(19) United States
(12) Patent Application Publication
(10) Pub. No.: US 2025/0263857 A1
(43) Pub. Date: Aug. 21, 2025

(54) BORON-DOPED COBALT/COBALT NITRIDE INTERFACIAL CATALYSTS, PROCESSES FOR MAKING, AND USES THEREOF

(71) Applicants: Honda Motor Co., Ltd., Tokyo (JP); Utah State University, Logan, UT (US)

(72) Inventors: Gugang CHEN, Palo Alto, CA (US); Shutang CHEN, Livermore, CA (US); Yi RAO, Logan, UT (US)

(21) Appl. No.: 18/444,410

(22) Filed: Feb. 16, 2024

(51) Int. Cl. C25B 11/091; C25B 1/04

(52) U.S. Cl. CPC C25B 11/091; C25B 1/04

(57) ABSTRACT

Aspects of the present disclosure generally relate to boron-doped cobalt/cobalt nitride interfacial catalysts, processes for making, and uses thereof. In an aspect, a process for forming a two-phase interface structure is provided. The process includes electrodepositing cobalt on a porous substrate. The process further includes exposing at least a portion of the cobalt deposited on the porous substrate to a boron-containing source to form a first composition comprising a boron-doped cobalt structure. The process further includes exposing at least a portion of the cobalt deposited on the porous substrate to a nitrogen-containing source to form a second composition comprising a two-phase interface structure, the two-phase interface structure comprising: a first phase comprising boron-doped cobalt; and a second phase comprising cobalt nitride.

### FIELD

Aspects of the present disclosure generally relate to boron-doped cobalt/cobalt nitride interfacial catalysts, processes for making, and uses thereof.

### BACKGROUND

Water splitting for hydrogen generation efficiently transforms renewable energy sources (e.g., solar and wind) into a clean and sustainable chemical fuel. The primary challenge in water splitting is the anodic oxygen evolution reaction (OER), which has very slow reaction kinetics and requires a large overpotential. Various non-noble electrocatalysts have been explored to overcome such obstacles, with 3d transition metal nitride (TMN)-based composites emerging as strong candidates due to their high conductivity, corrosion resistance, and optimized d-band electronic structure. TMN interfacial catalysts can accelerate electron transfer and optimize active site adsorption energetics, improving catalytic reactions. Although some conventional TMN interfacial catalysts show good performance in OER, more efforts are needed to meet future energy requirements. In addition, due to individual intrinsic characteristics of conventional catalysts, it is difficult to accurately adjust the electronic structure of the heterogeneous interface and distinguish the synergistic mechanism between metal center and the non-metal atom at the interfacial region during OER progress, which can be important for the design of non-noble electrocatalyst with high performance for water oxidation.

There is a need for new and improved interfacial catalysts. There is also a need for new and improved processes for making interfacial catalysts.

### SUMMARY

Aspects of the present disclosure generally relate to boron-doped cobalt/cobalt nitride (B—Co/Co₂N) interfacial catalysts, processes for making, and uses thereof. The interfacial catalysts described herein can be utilized as electrocatalysts for, e.g., oxygen evolution reaction (OER). B—Co/Co₂N interfacial catalysts of the present disclosure demonstrate superior catalytic performance in OER within an alkaline solution relative to conventional catalysts for OER.

In an aspect, a process for forming a two-phase interface structure is provided. The process includes electrodepositing cobalt on a porous substrate. The process further includes exposing at least a portion of the cobalt deposited on the porous substrate to a boron-containing source to form a first composition comprising a boron-doped cobalt structure. The process further includes exposing at least a portion of the cobalt deposited on the porous substrate to a nitrogen-containing source to form a second composition comprising a two-phase interface structure, the two-phase interface structure comprising: a first phase comprising boron-doped cobalt; and a second phase comprising cobalt nitride.

In another aspect, a process for forming a two-phase interface structure is provided. The process includes preparing a mixture comprising a cobalt source and an electrolyte. The process further includes electrodepositing cobalt on a porous substrate from the mixture at a current density that is from about −5.0 A/cm² to about −0.3 A/cm². The process further includes boriding at least a portion of the cobalt deposited on the porous substrate at a temperature of 400° C. or less to form a first composition comprising a boron-doped cobalt structure. The process further includes nitriding the first composition with ammonia gas at a temperature of about 200° C. to about 500° C. to form a second composition comprising a two-phase interface structure, the two-phase interface structure comprising: a first phase comprising boron-doped cobalt; and a second phase comprising cobalt nitride.

In another aspect, a two-phase interface structure is provided. The two-phase interface structure includes a first phase comprising boron-doped cobalt, and a second phase comprising cobalt nitride (Co₂N).

In another aspect is provided an oxygen evolution reaction electrocatalyst that includes a two-phase interface structure described herein.

In another aspect is provided a composition for water splitting that includes a two-phase interface structure described herein.

In another aspect is provided a catalyst for catalyzing and electrolyzing water to produce oxygen, the catalyst comprising a two-phase interface structure described herein.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1 shows an X-ray diffraction pattern of an example B—Co/Co₂N according to at least one aspect of the present disclosure.

FIGS. 2A-2C show X-ray photoelectron spectroscopy of an example B—Co/Co₂N according to at least one aspect of the present disclosure.

FIG. 2A shows a Co²p_{3/2} X-ray photoelectron spectrum of an example B—Co/Co₂N according to at least one aspect of the present disclosure.

FIG. 2B shows a N 1 s X-ray photoelectron spectrum of an example B—Co/Co₂N according to at least one aspect of the present disclosure.

FIG. 2C shows a B 1 s X-ray photoelectron spectrum of an example B—Co/Co₂N according to at least one aspect of the present disclosure.

FIG. 3A shows a scanning electron microscopy image of an example B—Co/Co₂N according to at least one aspect of the present disclosure. (Scale bar: 200 μm).

FIG. 3B shows a scanning electron microscopy image of an example B—Co/Co₂N according to at least one aspect of the present disclosure. (Scale bar: 2 μm).

FIG. 3C shows a high-resolution transmission electron microscopy image of an example B—Co/Co₂N according to at least one aspect of the present disclosure. (Scale bar: 10 nm).

FIGS. 3D-3G show elemental mapping images of merged elements, Co element, N element, and B element, respectively, of an example B—Co/Co₂N according to at least one aspect of the present disclosure. (Scale bar: 10 μm).

FIG. 4 shows an energy dispersive X-ray spectrum of an example B—Co/Co₂N according to at least one aspect of the present disclosure.

FIG. 5 shows linear sweep voltammetry (LSV) curves of example B—Co/Co₂N synthesized at different boriding temperatures for about 0.5 hours according to at least one aspect of the present disclosure. The LSV curves were collected in O₂-saturated 1.0 M potassium hydroxide (KOH) solution at a scan rate of about 5 mV/s.

FIG. 6 shows LSV curves of example B—Co/Co₂N synthesized at about 350° C. for different boriding times according to at least one aspect of the present disclosure. The LSV curves were collected in O₂-saturated 1.0 M KOH solution at a scan rate of about 5 mV/s.

FIGS. 7A and 7B shows (a) LSV curves and (b) a comparison of an example B—Co/Co₂N, Co/Co₂N, B—Co, and pristine Co under alkaline conditions (1.0 M KOH) according to at least one aspect of the present disclosure.

FIG. 7C shows Tafel plots of an example B—Co/Co₂N and comparative Co/Co₂N according to at least one aspect of the present disclosure.

FIG. 7D shows Nyquist plots of an example B—Co/Co₂N and comparative Co/Co₂N measured at 1.508 V vs reversible hydrogen electrode (RHE) according to at least one aspect of the present disclosure.

FIG. 7E shows chronopotentiometry curves of an example B—Co/Co₂N conducted at 100 mA/cm², 500 mA/cm², and 1000 mA/cm² in 1.0 M KOH according to at least one aspect of the present disclosure.

FIG. 7F shows a comparison of overpotentials of selected electrocatalysts to deliver 10 mA/cm² for water oxidation in 1.0 M KOH according to at least one aspect of the present disclosure.

FIG. 8 shows LSV curves of an example B—Co/Co₂N synthesized at about 350° C. for about 0.5 hours with varying amounts of boric acid for the boriding according to at least one aspect of the present disclosure. The LSV curves were collected in O₂-saturated 1.0 M KOH solution at a scan rate of about 5 mV/s.

### DETAILED DESCRIPTION

Aspects of the present disclosure generally relate to boron-doped cobalt/cobalt nitride interfacial catalysts, processes for making, and uses thereof. As described above, a significant obstacle in water splitting for hydrogen (H₂) generation is the complex four-electron process in anodic oxygen evolution reaction (OER), necessitating a large overpotential to counter its slow reaction kinetics. To overcome this obstacle, the inventors have developed an earth-abundant electrocatalyst with exceptional activity and stability for OER that can lower the reaction barrier, overcome the thermodynamic potential with low energy, and facilitate sustainable, large-scale industrial electrolysis. In some aspects, heteroatom dopant engineering is utilized to synthesize electrocatalysts. Presented herein is a facile synthesis method for a new boron-doped cobalt/cobalt nitride (B—Co/Co₂N) interfacial electrocatalyst. In some examples, the B—Co/Co₂N demonstrates superior oxygen evolution performance in alkaline solutions. At overpotentials of 262 mV and 310 mV, the synthesized B—Co/Co₂N can achieve excellent OER current densities of about 10 mA/cm² and 100 mA/cm², respectively. Additionally, B—Co/Co₂N catalysts described herein can exhibit excellent stability at industrial current densities (e.g., 500 mA/cm² and 1000 mA/cm²).

Interfacial catalysts described herein can be utilized for OER, can effectively and efficiently catalyze the reaction to generate hydrogen and oxygen, and compared with conventional catalysts, the synthesized catalyst described herein have higher high oxygen evolution efficiency, higher stability, and improved stability. In addition, the interface has faster charge transfer, so that the overpotential of oxygen evolution reaction can be reduced. Further, the electrochemical kinetics process of the OER can be improved by utilizing the rapid charge transfer at the interface of catalysts described herein, and the efficient and stable oxygen evolution of electrolyzed water can be realized.

Recently, electrically driven water splitting for H₂ generation has been considered as a currently ongoing frontier, which can efficiently convert renewable energy source (e.g. solar and wind) into clean and sustainable chemical fuel. Conventional non-noble electrocatalysts including transition metal phosphides, oxides, (oxy)hydroxides, nitrides, and selenides have been investigated as catalysts for OER. 3d transition metal nitride (TMN)-based composites—such as TMN interfacial catalysts, e.g., Ni₃N/MoN, Co_{5.47}N/Cu₃N, Co₂N/Mo₂N, Mo₂N—Co, and Co₂N—Ni—have been viewed as promising candidates for electrocatalytic oxygen evolution due to high conductivity, excellent corrosion resistance, together with redistributed d-band electronic structure. The construction of heterogeneous metal nitrides can effectively accelerate the electron transfer at interface and enhance the adsorption energetics of active sites nearby the heterogeneous interface, resulting in an improving the catalytic reaction.

Although some conventional TMN interfacial catalysts show improved performance in OER, more efforts are still needed to meet future energy demands. In addition, due to individual intrinsic characteristics, it is difficult to accurately adjust the electronic structure of the heterogeneous interface and distinguish the synergistic mechanism between metal center and the non-metal atom at the interfacial region during OER processes, which can be important for the design of non-noble electrocatalyst with high performance for water oxidation. That is, understanding and controlling the electronic structure of heterogeneous interfaces and the synergistic mechanism between metal centers and non-metal atoms can be important for designing high-performance non-noble electrocatalysts for water oxidation.

In some examples, heteroatom dopant engineering is utilized to synthesize electrocatalysts. As described herein, heteroatom dopant engineering can be used to modulate the electronic structure of catalytic sites, resulting in an improving reaction kinetics. For example, the introduction of boron—having unique electronegativity—can alter the electronic density of catalytic sites, lower the reaction barrier, accelerate charge transfer for enhancing reaction kinetics, while also efficiently withdrawing electrons from nearby metal sites, resulting in a high oxidation state of metal center for favorable oxygen evolution. In addition, the boron dopant can be used as a Lewis acid to combine with positively charged intermediates during electrocatalytic process, resulting in enhanced OER performance evolution. To the inventors' knowledge, boron-doped TMN interfacial catalysts for oxygen evolution in alkaline solution is not known.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

Aspects of the present disclosure generally relate to processes for forming boron-doped cobalt/cobalt nitride (B—Co/Co₂N) materials. The B—Co/Co₂N may be used as catalysts or for other applications. In some embodiments the process generally includes the following non-limiting operations:
(a) performing an electrodeposition of cobalt (e.g., cobalt particles) onto a porous substrate;
(b) boriding at least a portion of the cobalt deposited on the porous substrate to form boron-doped cobalt structures and/or phases; and
(c) nitriding at least a portion of the cobalt deposited on the porous substrate to form a two phase interface structure comprising: a first phase comprising boron-doped cobalt; and a second phase comprising cobalt nitride.

With respect to operation (a), the electrodeposition of cobalt can be performed in an electrochemical cell that includes the porous substrate, a cobalt source, and an electrolyte. Examples of suitable porous substrates can include metallic foams (e.g., nickel foams, nickel iron foams, or stainless steel foams), or non-metallic foams (e.g., carbon foams, graphite foams, or graphene foams. Other porous substrates can be included in place of, or in combination with, metallic or non-metallic foams, such as metallic or non-metallic foils or meshes, such as nickel foils or meshes, stainless steel foils or meshes, nickel chromium foils or meshes, or nickel ferrous alloy foils or meshes. Other porous substrates are contemplated. The electrodeposition can be in the form of a cathodic electrodeposition of cobalt.

Any suitable cobalt source can be utilized for operation (a). Useful cobalt precursors include cobalt and one or more ligands such as halide (for example, I⁻, Br⁻, Cl⁻, or F⁻), sulfate (SO₄²⁻), acetylacetonate (O₂C₅H₇⁻), hydride (H⁻), SCN⁻, NO₂⁻, NO₃⁻, N₃⁻, OH⁻, oxalate (C₂O₄²⁻), H₂O, acetate (CH₃COO⁻), O₂⁻, CN⁻, OCN⁻, OCN⁻, CNO⁻, NH₂⁻, NH₂⁻, NC⁻, NCS⁻, N(CN)₂⁻, pyridine (py), ethylenediamine (en), 2,2′-bipyridine (bipy), PPh₃, hydrates thereof, or combinations thereof.

Illustrative, but non-limiting, examples of cobalt sources can include: cobalt chloride (CoCl₂) or hydrate thereof (CoCl₂(H₂O)ₓ), for example, CoCl₂·6H₂O; cobalt sulfate (CoSO₄) or hydrate thereof (CoSO₄(H₂O)ₓ), for example, CoSO₄·6H₂O or CoSO₄·7H₂O; cobalt nitrate (Co(NO₃)₂) or hydrate thereof (Co(NO₃)₂(H₂O)ₓ), for example Co(NO₃)₂·6H₂O; cobalt acetate (Co(CH₃CO₂)₂) or hydrate thereof (Co(CH₃CO₂)₂(H₂O)ₓ), for example Co(CH₃CO₂)₂·4H₂O; or combinations thereof. Other cobalt sources are contemplated. In some examples, CoCl₂, CoSO₄, or a hydrate thereof is utilized as the cobalt source. More than one cobalt source can be utilized in any suitable proportion.

Any suitable electrolyte can be utilized for operation (a). The electrolyte can be pure water or a solution that includes at least one halide salt and a solvent, the solvent comprising water and/or an organic solvent. The halide salt can include, but is not limited to, ammonium chloride (NH₄Cl), tin chloride (SnCl₂), ammonium fluoride (NH₄F), ammonium bromide (NH₄Br), hydrates thereof, or combinations thereof. Other electrolytes are contemplated.

In cases where the electrolyte being used in the electrochemical cell is a solution of a halide salt in an organic solvent, the organic solvent can be any suitable organic solvent such as a polar organic solvent. Polar organic solvents can include, but are not limited to, any suitable straight or branched C₁-C₆ alkanol such as methanol, ethanol, propanol, isopropanol, butanol, isobutanol, sec-butanol, tert-butanol, pentanol, neopentanol, sec-pentanol, hexanol or a mixture thereof, such as ethanol. The halide salt electrolyte used in the electrochemical cell can be dissolved in water, optionally supplemented with a polar organic solvent, or it can be dissolved in a polar organic solvent optionally supplemented with water.

The electrodeposition can be performed in any suitable cell, such as a two-electrode configuration in a cell, or a two electrode configuration in a cell. The electrodeposition of operation (a) can be performed at any suitable current density for any suitable duration. In some examples, the current density can be from about −10.0 A/cm² to about −0.05 A/cm², such as from about −8.0 A/cm² to about −0.1 A/cm², such as from about −5.0 A/cm² to about −0.3 A/cm², such as from about −3.0 A/cm² to about −0.5 A/cm², such as from about −2.0 A/cm² to about −0.75 A/cm², such as from about −1.5 A/cm² to about −0.9 A/cm², such as about −1.0 A/cm², though other values are contemplated. Any of the foregoing numbers can be used singly to describe an open-ended range or in combination to describe a close-ended range. The current density can be constant or can be adjusted as desired during electrodeposition. The negative current densities indicate cathodic reaction.

The duration of the electrodeposition (electrodeposition duration) can be any suitable duration such as from about 30 seconds to about 1,800 seconds, such as from about 50 seconds to about 1,500 seconds, such as from about 100 seconds to about 1,200 seconds, such as from about 200 seconds to about 1,000 seconds, such as from about 300 seconds to about 800 seconds, such as from about 400 seconds to about 600 seconds, such as about 500 seconds, though other values are contemplated. Any of the foregoing numbers can be used singly to describe an open-ended range or in combination to describe a close-ended range.

The electrodeposition of operation (a) can be performed with or without stirring. The components of the electrodeposition mixture of operation (a) can be mixed, stirred, or agitated, at room temperature or a different temperature, by using suitable devices such as a mechanical stirrer, such as an overhead stirrer, a magnetic stirrer (for example, placing a magnetic stir bar in the vessel above a magnetic stirrer), or other suitable devices. Components of the reaction mixture at operation (a) can be mixed, stirred, or agitated in the presence of a non-reactive gas, such as nitrogen (N₂), argon (Ar), or combinations thereof. For example, a non-reactive gas can be introduced with one or components in the mixture to degas various components or otherwise remove unwanted gases such as oxygen from the mixture.

The temperature during electrodeposition can be any suitable temperature such as from about 5° C. to about 50° C., such as from about 10° C. to about 40° C., such as about room temperature (from about 15° C. to about 25° C.), though other values are contemplated. Any of the foregoing numbers can be used singly to describe an open-ended range or in combination to describe a close-ended range.

The electrodeposition of operation (a) results in cobalt (e.g., in the form of particles) deposited on the porous substrate, e.g., a cobalt electrode.

With respect to operation (b), the boriding (also called boronizing) at least a portion of the cobalt deposited on the porous substrate (e.g., the cobalt electrode) can include exposing the cobalt deposited on the porous substrate to a boron-containing source under conditions sufficient to convert at least a portion of the cobalt to boron-doped cobalt structures and/or phases. The boron-doped cobalt structures and/or phases can comprise an alloy that includes cobalt and boron.

The boriding causes boron to diffuse into and combine with the cobalt to form a boron-cobalt (B—Co) structure and/or phase comprising boron and cobalt. The boriding of operation (b) results in at least a portion of the cobalt deposited on the porous substrate to be converted to the boron-doped cobalt structure and/or phase. Following boriding, a first composition comprising a phase that includes cobalt metal and a phase that includes the boron-doped cobalt is formed.

Any suitable boron-containing source can be utilized for operation (b). The boron-containing source can be amorphous, crystalline, liquid, or gas phase. Illustrative, but non-limiting, boron-containing sources can include: ferroboron; boron carbide (B₄C); borax; boric acid (H₃BO₃); diborane (B₂H₆); organic boron-containing sources such as trimethyl borate, triethyl borane, or borane triethylamine complex, among others; an alkali borate such as lithium borate (Li₂B₄O₇), sodium borate (Na₂B₄O₇), or potassium borate (K₂B₄O₇), sodium tetrafluoroborate (NaBF₄), among others; or a boron halide such as boron trichloride (BCl₃). Combinations of boron-containing sources can be utilized. Selection of the boron-containing source can depend on the method of boriding, e.g., physical vapor deposition, chemical vapor deposition, or electrochemical deposition.

An amount of boron-containing source is utilized such that the resulting first composition has a molar ratio of boron to total cobalt (cobalt metal plus the boron-doped cobalt, B:Co(total)) that is from about 0.01:1 to about 0.3:1, such as from about 0.03:1 to about 0.25:1, such as from about 0.05:1 to about 0.2:1, such as from about 0.07:1 to about 0.15:1, such as from about 0.08:1 to about 0.12:1, such as from about 0.09:1 to about 0.1:1, though other values are contemplated. Any of the foregoing numbers can be used singly to describe an open-ended range or in combination to describe a close-ended range.

The temperature during boriding (a boriding temperature) can be any suitable temperature such as from about 200° C. to about 500° C., such as from about 250° C. to about 450° C., such as from about 300° C. to about 400° C., such as from about 325° C. to about 375° C., such as about 350° C., though other values are contemplated. Any of the foregoing numbers can be used singly to describe an open-ended range or in combination to describe a close-ended range. In some embodiments, a low-temperature (e.g., 400° C. or less) boron doping of cobalt is utilized for the boriding, such as from about 200° C. to about 400° C., such as from about 300° C. to about 375° C.

The duration of the boriding (a boriding duration) can be any suitable duration such as from about 5 minutes to about 10 hours, such as from about 15 minutes to about 5 hours, such as from about 30 minutes to about 3 hours, such as from about 1 hour to about 2 hours, or from about 1.5 hours to about 5 hours, such as from about 2 hours to about 4 hours, such as about 3 hours, though other values are contemplated. Any of the foregoing numbers can be used singly to describe an open-ended range or in combination to describe a close-ended range.

The boriding process of operation (b) can be performed in any suitable processing chamber such as a physical vapor deposition (PVD) chamber, a chemical vapor deposition (CVD) chamber, an electrochemical chamber, or other suitable processing chamber. The processing chamber can be a heating chamber such as a tube furnace, e.g., a quartz tube.

The substrate for the boriding (e.g., Co electrode) can be positioned near or above a heating mechanism (e.g., a heating wire, heating belt, an oven, a furnace) of the chamber. The boron-containing source can be positioned in the chamber upstream of the substrate. The temperature of the chamber where the substrate is positioned can be elevated to a desired temperature (e.g., a boriding temperature described herein) at a suitable ramping rate. Suitable ramping rates can include a ramping rate that is from about 1° C./min to about 20° C./min, such as from about 5° C./min to about 15° C./min, such as about 10° C./min, though other values are contemplated. Any of the foregoing numbers can be used singly to describe an open-ended range or in combination to describe a close-ended range. Once the desired boriding temperature is reached, the temperature can be maintained for a desired duration (e.g., a boriding duration described herein).

In some examples, the boron-containing source that is positioned upstream of the substrate can also be heated to, e.g., aid in vaporizing the boron-containing source. The temperature at which the boron-containing source is heating can depend on properties of the boron-containing source, such as a temperature at which the boron-containing source can be converted to a vapor form of the boron-containing source.

The processing chamber for the boriding process of operation (b) can include an inlet and an outlet, where a gas, if used, is coupled to the inlet. Suitable gases can include He, Ar, Kr, Ne, Xe, N₂, or combinations thereof. The gas can be utilized to flush the chamber. Additionally, or alternatively, the gas can be utilized as a carrier gas. When a carrier gas is utilized, a flow rate of the carrier gas can be from about 20 standard cubic centimeter per minute (sccm) to about 200 sccm, such as from about 50 sccm to about 150 sccm, such as from about 75 sccm to about 125 sccm, such as about 80 sccm, though other flow rates are contemplated. Any of the foregoing numbers can be used singly to describe an open-ended range or in combination to describe a close-ended range. Generally, the boriding operation includes heating and vaporizing the boron source, and the carrier gas comprising He, Ar, Kr, Ne, Xe, N₂, or combinations thereof aids the flow of the vaporized boron source to boride at least a portion of the cobalt deposited on the porous substrate.

The boriding of operation (b) results in at least a portion of the cobalt deposited on the porous substrate to a boron-doped cobalt structure and/or phase comprising boron and cobalt. Following boriding, a first composition comprising a cobalt metal and a phase that includes the boron-doped cobalt is formed.

In some examples, the boron-doped cobalt can exist as a BₓCo_{y} phase, where x:y is a molar ratio of the boron to the cobalt in that BₓCo_{y} phase. A molar ratio of x:y in the BₓCo_{y} phase can be from about 0.001:1 to about 0.05:1, such as from about 0.003:1 to about 0.03:1, such as from about 0.01:1 to about 0.02:1, though other values are contemplated. Any of the foregoing numbers can be used singly to describe an open-ended range or in combination to describe a close-ended range.

With respect to operation (c), the nitriding at least a portion of the cobalt deposited on the porous substrate (e.g., the cobalt particles that are not borided) can include exposing the cobalt deposited on the porous substrate to a nitrogen-containing source under conditions sufficient to convert at least a portion of the cobalt to cobalt nitride (e.g., Co₂N, Co₃N, Co₄N, and/or Co₃N₂, such as Co₂N) structures and/or phases. The nitriding causes nitrogen to diffuse into and combine with the cobalt to form the cobalt nitride structure and/or phase. After nitriding, a second composition is formed, wherein the second composition comprises a first phase that includes the boron-doped cobalt and a second phase that includes the cobalt nitride.

Any suitable nitrogen-containing source can be utilized for operation (c). The nitrogen containing source can be a nitriding gas. Suitable nitriding gases can include, but are not limited to, ammonia (NH₃) gas, diazene (N₂H₂) gas, hydrazine (N₂H₄) gas, N₃H₈ gas, or combinations, among others. Optionally, a non-reactive gas such as He, Ar, Kr, Ne, Xe, N₂, or combinations thereof, such as Ar, can be utilized during the nitriding.

The nitriding process of operation (c) can be performed in any suitable processing chamber such as a PVD chamber, a CVD chamber, or other suitable processing chamber. The processing chamber can be a heating chamber such as a tube furnace, e.g., a quartz tube. The chamber for the nitriding process of operation (c) can be the same chamber as that used during operation (b) or it can be a different chamber. The processing chamber for the nitriding process of operation (c) includes an inlet and an outlet. The nitrogen-containing gas can flow into the chamber through the inlet. When an optional non-reactive gas is used, the non-reactive gas can flow into the same inlet or a different inlet. In some examples, the nitriding is a thermal nitridation.

An amount of nitrogen-containing source (e.g., nitriding gas) can be utilized such that at least a portion of the cobalt particles present in the first composition are converted to Co₂N. In some examples, the nitriding gas is flown into the chamber such that the chamber is saturated with nitriding gas.

Any suitable amount of nitrogen-containing source is utilized such that the resulting second composition has a molar ratio of nitrogen to total cobalt that is from about 0.03:1 to about 0.6:1, such as from about 0.05:1 to about 0.5:1, such as from about 0.1:1 to about 0.3:1, such as from about 0.15:1 to about 0.25:1, such as from about 0.17:1 to about 0.22:1, such as from about 0.19:1 to about 0.21:1, such as about 0.2:1, though other values are contemplated. Any of the foregoing numbers can be used singly to describe an open-ended range or in combination to describe a close-ended range.

The temperature during nitriding (a nitriding temperature) can be any suitable temperature such as from about 200° C. to about 500° C., such as from about 250° C. to about 450° C., such as from about 300° C. to about 400° C., such as from about 325° C. to about 375° C., such as about 350° C., though other values are contemplated. Any of the foregoing numbers can be used singly to describe an open-ended range or in combination to describe a close-ended range.

The duration of the nitriding (a nitriding duration) can be any suitable duration such as from about 5 minutes to about 10 hours, such as from about 15 minutes to about 5 hours, such as from about 30 minutes to about 3 hours, such as from about 1 hour to about 2.5 hours, or from about 1.5 hours to about 3 hours, such as about 2 hours, though other values are contemplated. Any of the foregoing numbers can be used singly to describe an open-ended range or in combination to describe a close-ended range.

The substrate for the nitriding (e.g., the first composition comprising the cobalt particles and boron-doped cobalt, such as a B—Co electrode) can be positioned near or above a heating mechanism (e.g., a heating wire, heating belt, an oven, a furnace) of the chamber. The nitriding gas can be flown into the chamber. Optionally, the non-reactive gas can be flown into the chamber. The temperature of the chamber where the substrate for nitriding is positioned can be elevated to a desired temperature (e.g., a nitriding temperature described herein) at a suitable ramping rate. Suitable ramping rates can include a ramping rate that is from about 1° C./min to about 20° C./min, such as from about 5° C./min to about 15° C./min, such as about 10° C./min, though other values are contemplated. Any of the foregoing numbers can be used singly to describe an open-ended range or in combination to describe a close-ended range. Once the desired nitriding temperature is reached, the temperature can be maintained for a desired duration (e.g., a nitriding duration described herein).

The nitridation of operation (c) results in a second composition, wherein the second composition comprises a first phase that includes the boron-doped cobalt (B—Co) and a second phase that includes the cobalt nitride (Co₂N). That is, the second composition can include B—Co/Co₂N interfacial catalysts. The second composition may further include the porous substrate such as a foam. In those cases, the second composition can include B—Co/Co₂N/foam interfacial catalysts, such as B—Co/Co₂N/NF interfacial catalysts where the “NF” refers to nickel foam. Other porous substrates described herein can replace the nickel foam.

B—Co/Co₂N interfacial catalysts described herein can be utilized for water splitting, OER, and hydrogen evolution reaction (HER), among other applications. The B—Co/Co₂N interfacial catalysts can form at least a portion of an electrode such as at least a portion of an anode and/or at least a portion of a cathode. That is, B—Co/Co₂N interfacial catalysts can be used as an anode catalyst and/or a cathode catalyst.

Water electrolysis can be performed to produce hydrogen and/or oxygen by placing an anode and a cathode into an alkaline electrolyte solution. The anode can include an anode catalyst comprising B—Co/Co₂N. The alkaline electrolyte solution comprises an alkali metal hydroxide such as sodium hydroxide, potassium hydroxide, lithium hydroxide, or combinations thereof. A concentration of the alkali metal hydroxide in the alkaline electrolyte solution can be any suitable concentration such as from about 0.5 M to about 10 M, such as from about 1 M to about 6 M, such as from about 2 M to about 4 M, or from about 0.5 M to about 3 M, such as from about 0.75 M to about 2 M, such as about 1M, though other values are contemplated. Any of the foregoing numbers can be used singly to describe an open-ended range or in combination to describe a close-ended range. The water electrolysis can be performed at any suitable temperature such as from about 5° C. to about 90° C., such as from about 10° C. to about 60° C., such as from about 15° C. to about 30° C., such as from about 15° C. to about 25° C., though other values are contemplated. Any of the foregoing numbers can be used singly to describe an open-ended range or in combination to describe a close-ended range. Electric energy can be applied to the cell that drives the reaction to decompose water to produce oxygen and/or hydrogen. B—Co/Co₂N interfacial catalysts serve to catalyze and/or electrolyze the water to produce the oxygen and/or the hydrogen.

B—Co/Co₂N interfacial catalysts described herein can have a low Tafel slope. In some embodiments, a B—Co/Co₂N interfacial catalyst described herein has a Tafel slope that can be from about 10 mV/dec to about 100 mV/dec, such as from about 15 mV/dec to about 80 mV/dec, such as from about 20 to about 60 mV/dec, such as from about 25 mV/dec to about 50 mV/dec, such as from 30 mV/dec to about 40 mV/dec, such as about 30.5 mV/dec, though other values are contemplated. Any of the foregoing numbers can be used singly to describe an open-ended range or in combination to describe a close-ended range. Tafel slope is determined as shown in the Examples Section.

B—Co/Co₂N heterostructures described herein have improved performance over sluggish electrocatalytic performance of conventional transition metal-based electrocatalysts. The boron atom doping may lead to lattice distortion and abundant superficial defects on the crystal surface, which will generate more active sites and faster charge transformations. The heterointerface between B—Co and Co₂N can lead to electronic structure modulation at the interface domain, which induces fresh active sites in this area, and can enhance the active sites to an improved state for. As a result, and in some examples, B—Co/Co₂N interfacial catalysts described herein utilize low overpotentials to produce high current densities for, e.g., OER and HER in alkaline solution. B—Co/Co₂N interfacial catalysts described herein exhibit outstanding water splitting performance in, e.g., alkaline solution, as well as excellent catalytic long-term durability.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (for example, amounts, dimensions, etc.) but some experimental errors and deviations should be accounted for.

### EXAMPLES

Examples of catalysts described herein were made using various materials set out in the Materials and are described further below. Selected properties of the compositions were measured using Test Methods.

### Materials

Ammonium chloride (NH₄Cl, 95%), cobalt chloride (CoCl₂·6H₂O, 99.4%), and potassium hydroxide (KOH, 90%) are commercially available from Fisher Chemical. Boric acid (H₃BO₃) was purchased from Sigma-Aldrich. Ammonia (NH₃) gas is commercially available from Praxair. All commercially obtained chemicals were used as received without further purification. Water utilized in the experiments was deionized (18 MΩ·cm) with a Barnstead E-Pure system.

### Test Methods

### 1. Characterization

Scanning electron microscopy (SEM) measurement and elemental mapping analysis were conducted on an FEI Quanta 650 FEG microscope equipped with an INCA 350 spectrometer (Oxford Instruments) for energy dispersive X-ray (EDX) spectroscopy. Transmission electron microscopy (TEM) measurement was carried out on an FEI Tecnai G2 F20 FE-TEM (FEI, USA).

X-ray diffraction (XRD) patterns were obtained on a Rigaku MinifexII Desktop X-ray diffractometer. X-ray photoelectron spectroscopy (XPS) measurements were performed using a Kratos Axis Ultra instrument (Kratos Analytical Ltd.).

### 2. Electrochemical Measurements

Linear sweep voltammetry (LSV), cyclic voltammetry (CV), chronopotentiometry (CP), and chronoamperometry (CA) experiments were conducted using a Gamry Interface 1000 electrochemical workstation with a three-electrode configuration. The B—Co/Co₂N was directly used as the working electrode. A calibrated Hg/HgCl (saturated KCl) with a salt bridge kit and a carbon rod were used as the reference and counter electrodes, respectively. The electrolyte for OER was 1.0 M KOH (pH 13.85). All electrolytes were bubbled with O₂ throughout the electrochemical experiments. All potentials are provided with respect to a reversible hydrogen electrode (RHE) according to Equation 1:

$$E ( vs . RHE ) = E ( vs . Ag / AgCl ) + 0.197 + 0.059 \times pH \qquad ( Eq . 1 )$$

The LSV and CV curves were collected at 5 mV s⁻¹. Unless stated otherwise, all LSV curves for OER were iR-corrected and obtained by scanning from negative to negative potential. The correction was made according to Equation 2:

$${E}_{corrected} = {E}_{measured} - {iR}_{s} \qquad ( Eq . 2 )$$

wherein: E_{corrected} is the iR-corrected potential, E_{measured} and i are experimentally measured potential and current, respectively; and R₈ is the equivalent series resistance measured via electrochemical impedance spectroscopy in the frequency range of 10⁶-0.01 Hz.

The catalytic stability was evaluated by either CP or CA measurement without iR correction.

### Example: Preparation of Example Electrocatalysts

Synthesis of Boron-doped Cobalt (B—Co). B—Co electrodes were prepared by cathodic electrodeposition of cobalt (Co) particles on commercial foam (nickel metal foam) followed by thermal boriding. The electrodeposition was carried out with a two-electrode configuration in a cell that included 2.0 M NH₄Cl and 0.1 M CoCl₂ at room temperature. The electrodeposition was performed at a constant current density of −1.0 A/cm² for 500 seconds under a nitrogen (N₂) atmosphere without stirring to obtain a Co electrode. Various foams were investigated for the electrodeposition.

Subsequently, the resulting Co electrode was placed at the center of a tube furnace, and a desired amount of boric acid (H₃BO₃) was placed at the upstream side of the furnace. After flushing with argon (Ar) gas for 2 hours, a temperature at the center of the furnace was elevated to the desired temperature at a ramping rate of about 10° C./min and maintained at the same temperature for a given duration. After cooling to room temperature, the boron-doped cobalt was obtained. Various B—Co materials were made having different molar ratios of B:Co. Various temperatures, such as 200° C., 250° C., 350° C., 400° C., 450° C., and 500° C., as well as durations, such as 0.25 h, 0.5 h, 1 h, 2, h, 3, h, 4, h, and 5 h, were investigated to obtain different B—Co materials as further described below. In addition, various boron-containing sources other than boric acid were investigated such as BCl₃ to obtain different B—Co materials. Amounts of boron-containing sources can be altered to obtain different B—Co materials such as 30 mg, 60 mg, 100 mg, 120 mg, and 250 mg.

Synthesis of Boron-doped Cobalt/Cobalt Nitride (B—Co/Co₂N). The boron-doped cobalt was placed in the center of a quartz tube purged with a flow of ammonia (NH₃) gas. In a saturated NH₃ environment, the tube was then heated to a temperature of 350° C. for 2 hours. The temperature and time for the nitridation can vary. After allowing the quartz tube to cool to room temperature, the B—Co/Co₂N catalyst was obtained. The flow of NH₃ and was maintained throughout the synthesis. The B—Co/Co₂N catalyst formed had a molar ratio of Co:N:B of about 0.78:0.15:0.07. Various B—Co/Co₂N materials having different molar ratios of Co:N:B were obtained by adjusting, e.g., the starting amounts of CoCl₂ and/or boric acid. It is noted that after nitridation, the foam is still present such that the product can include B—Co/Co₂N/foam.

In the above non-limiting example, B—Co/Co₂N catalysts are synthesized by a three-step approach that includes: (1) the electrodeposition of porous cobalt (Co) on commercial foam, (2) followed by a low-temperature boron doping (boriding), and then (3) thermal nitridation.

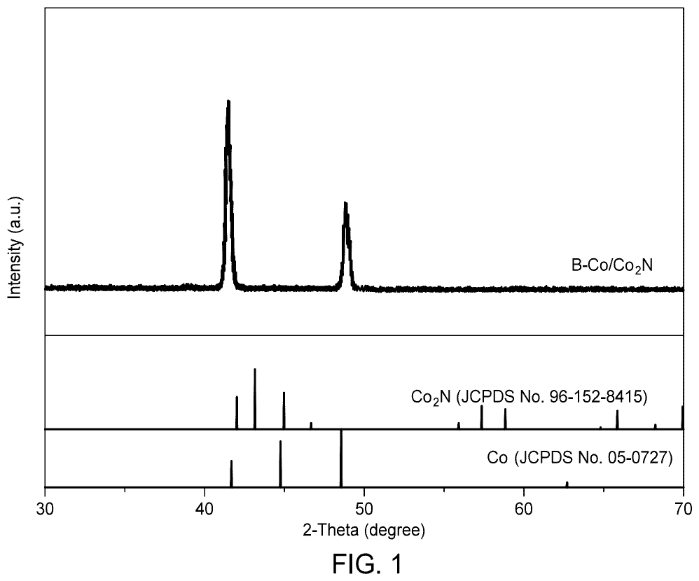

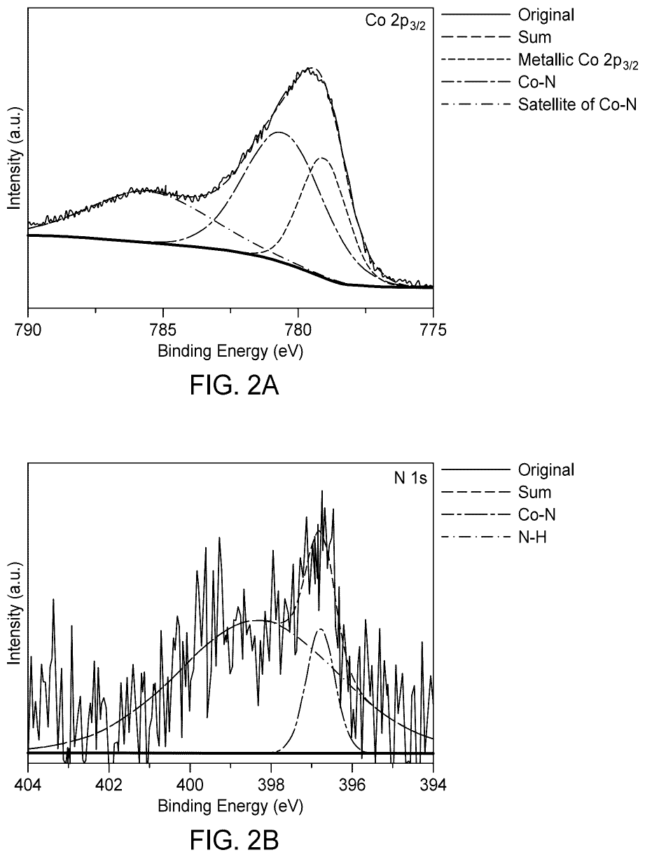

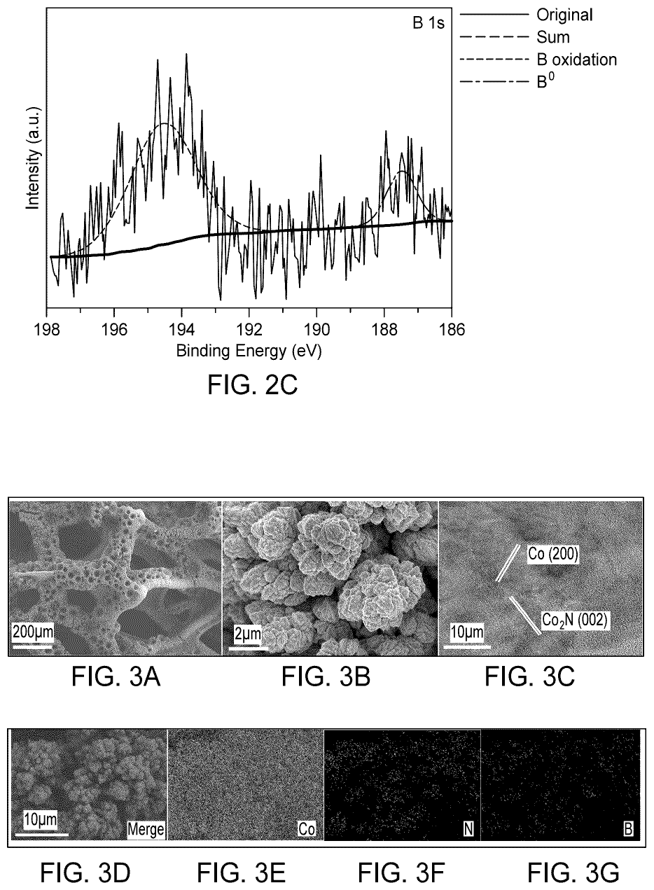

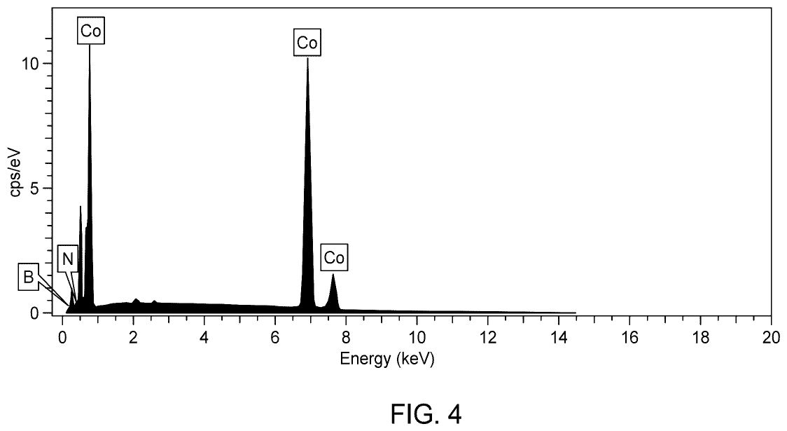

Powder X-ray diffraction (XRD) was performed. As shown in FIG. 1, the diffraction peaks of B—Co/Co₂N agree well to the Co₂N (JCPDS No. 96-152-8415) and Co (JCPDS No. 05-0727) and no additional diffraction peaks exist, indicating the co-existence of Co and Co₂N in the samples. X-ray photoelectron spectroscopy (XPS) was carried out to probe the surface chemical composition and valence state of the sample. For the high resolution Co²p_{3/2} spectrum shown in FIG. 2A, two peaks of 779.1 eV and 780.7 eV were assigned to metallic Co and Co—N with its satellite peak at 785.7 eV, respectively. The N 1 s spectrum in FIG. 2B can be fit into two peaks at 396.7 and 398.3 eV, which is attributed to Co—N bond and residual NH moieties from incomplete reaction of NH₃. FIG. 2C shows a high resolution B is spectrum. The peaks for elemental B⁰ and boron oxidation species was observed at 187.3 eV and 194.5 eV, suggesting the feasibility of B doping strategy.

As exhibited in the scanning electron microscopy (SEM) image of FIG. 3A, the as-synthesized B—Co/Co₂N exhibited a three-dimensional (3D) macroporous network with a pore size ranging from about 10 μm to 20 about μm. The high-magnification SEM image in FIG. 3B demonstrated that the surfaces are composed of enormous microspheres with an average particle size of 2.5 μm. Such a unique 3D structure not only provides a high mass of active catalytic sites, but also accelerates the charge and mass transfer, resulting in an improvement of electrochemical performance. The high-resolution transmission electron microscopy (HR-TEM) was also conducted to investigate the microstructure of B—Co/Co₂N. As shown in FIG. 3C, the lattice fringes of 0.218 nm and 0.178 nm are attributed to the (002) plane of Co₂N and (200) plane of Co, respectively. The high-angle annular dark field-scanning transmission electron microscopy (HAADF-STEM) image further shows that the elements of Co (FIG. 3E), N (FIG. 3F), and B (FIG. 3G) are well dispersed throughout the entire B—Co/Co₂N surface and the corresponding molar ratio of Co:N:B was estimated to be about 0.78:0.15:0.07. Overall, the aforementioned results indicate that B-doped Co/Co₂N interfacial electrocatalysts with a unique 3D structure can be synthesized according to aspects described herein.

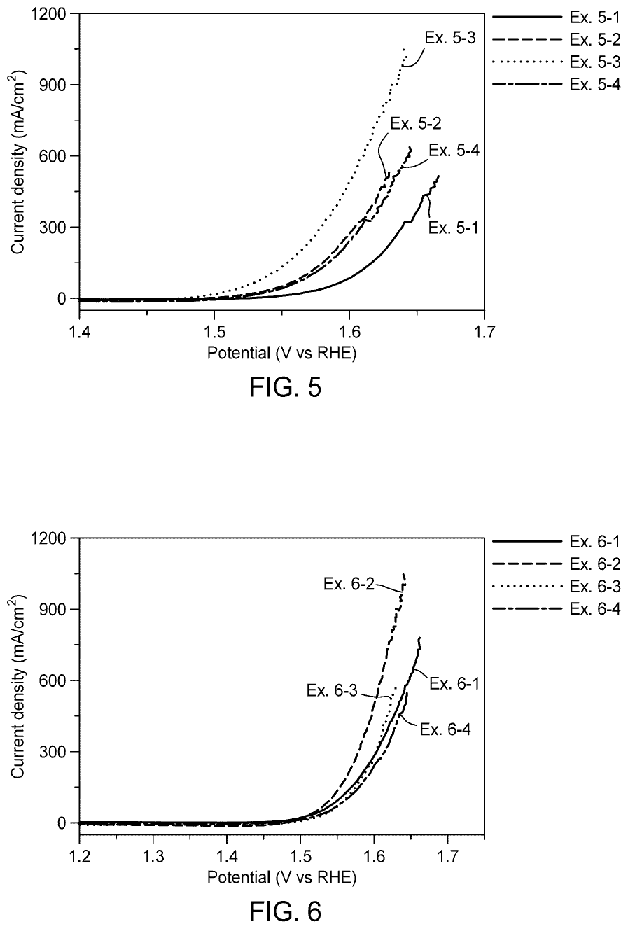

The OER performance of various catalysts was evaluated in an O₂-saturated 1.0 M KOH solution via a typical three-electrode configuration. To exclude the signal of catalyst oxidation, LSV curves were obtained from high potential to low potential (negative scan) with a scan rate of 5 mV/s and corrected by iR compensation. The effect of boriding conditions on OER activity was first investigated in FIGS. 5 and 6. Table 1 shows non-limiting boriding conditions investigated with results shown in FIGS. 5 and 6.

TABLE 1

| Example | Boriding Conditions |
|---|---|
| Ex. 5-1 | No boriding |
| Ex. 5-2 | 300° C., 0.5 h |
| Ex. 5-3 | 350° C., 0.5 h |
| Ex. 5-4 | 400° C., 0.5 h |
| Ex. 6-1 | 350° C., 0.25 h |
| Ex. 6-2 | 350° C., 0.5 h |
| Ex. 6-3 | 350° C., 1 h |
| Ex. 6-4 | 350° C., 3 h |

All examples 5-2 to 5-4 and 6-1 to 6-4 showed excellent OER performance. Among all the examples shown in Table 1, the B—Co/Co₂N catalyst formed at a temperature of about 350° C. a reaction time of about 0.5 hour (h) showed the best OER performance in alkaline (1.0 M KOH) solution.

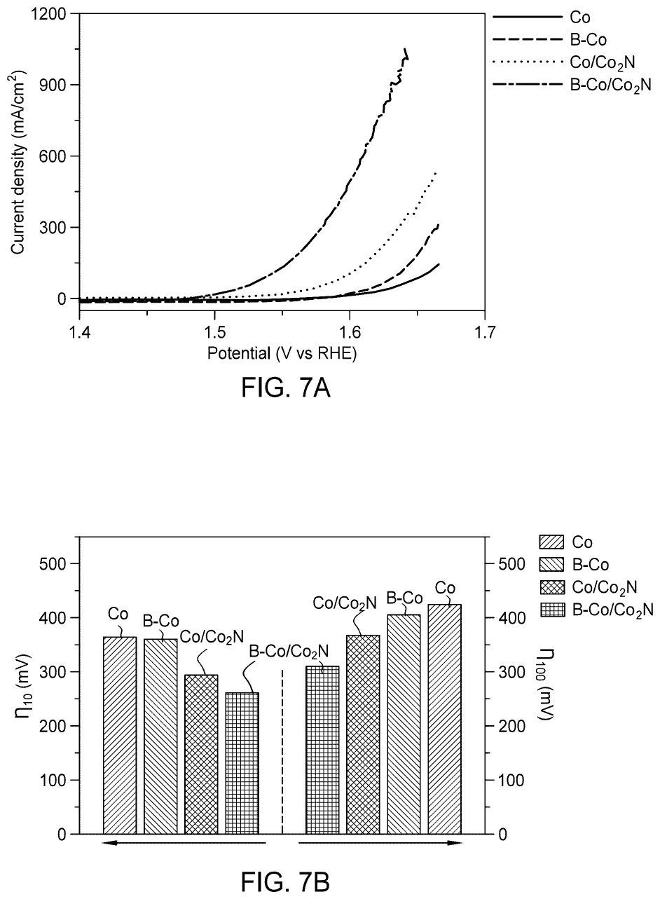

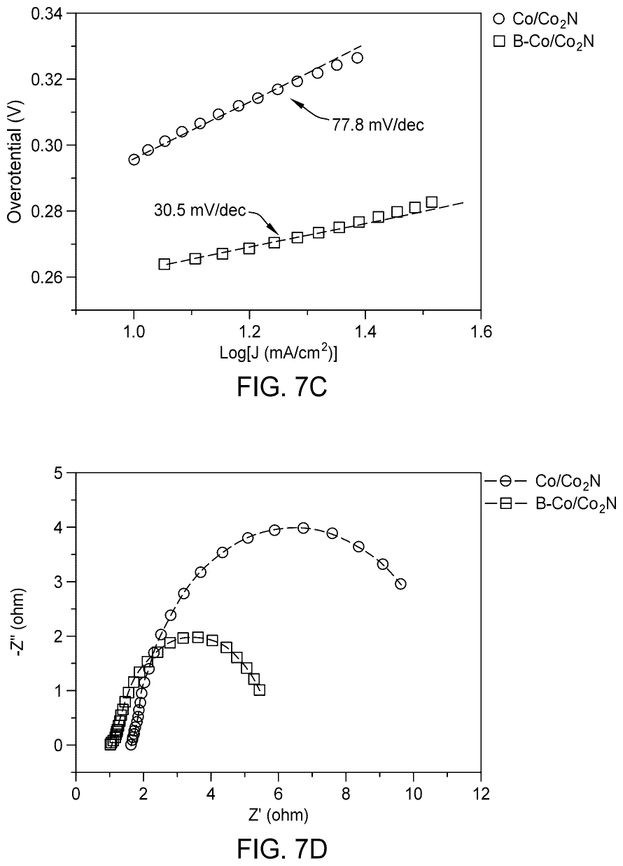

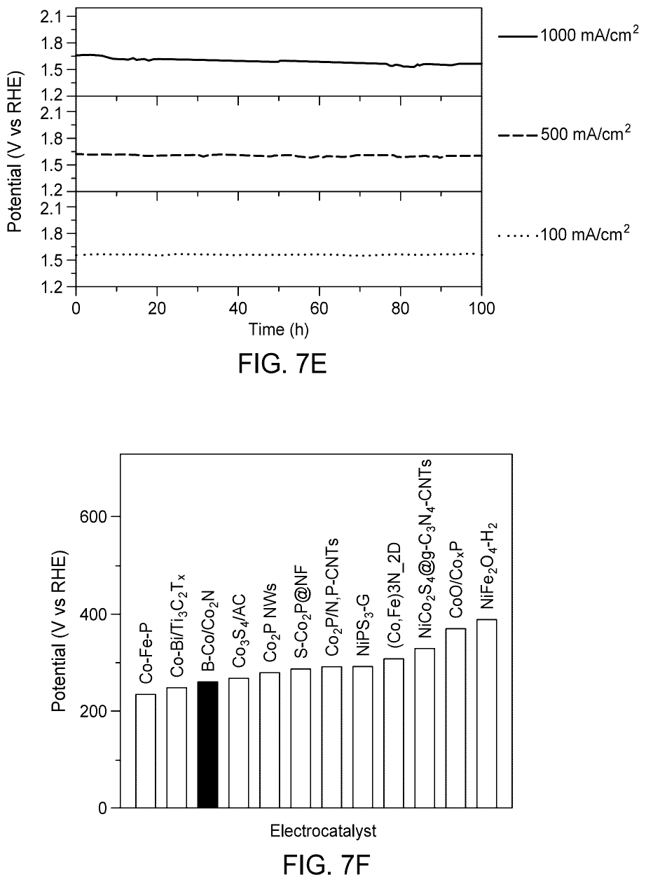

FIGS. 7A and 7B compare the OER catalytic performance of B—Co/Co₂N, Co/Co₂N, B—Co, and pristine Co under alkaline conditions. The B—Co/Co₂N electrocatalyst shows excellent OER catalytic properties, with overpotentials of about 262 mV and 310 mV to afford current densities of about 10 mA/cm² and about 100 mA/cm², respectively, which are significantly lower than of Co/Co₂N (295 and 368 mV), B—Co (361 and 405 mV), and pristine Co (363 and 455 mV).

The catalytic performance of B—Co/Co₂N (entry 1) is also comparable to most non-precious OER catalysts reported (See Table 2 and FIG. 7F), including conventional catalysts Co—Fe—P (entry 2), Co₃S₄/AC (entry 4), Co₂P NWs (entry 5), Co₂P/N,P co-doped CNT (entry 7), NiPS₃-G (entry 8), CoO/CoₓP (entry 11), and NiFe₂O₄—H₂ (entry 12). The electrolyte used for the electrocatalytic OER activity for all catalysts shown in Table 2 is 1.0 M KOH. In Table 2, J refers to current density and η refers to overpotential.

TABLE 2
Comparison of Electrocatalytic OER Activity
of Various Non-precious Metal Catalysts

| | | J, | η, |
|---|---|---|---|
| Entry | Catalysts | mA/cm² | mV |
| 1 | B—Co/Co₂N | 10 | 262 |
| 2 | Co—Fe—P | 10 | 235 |
| 3 | Co—Bi/Ti₃C₂Tₓ | 10 | 250 |
| 4 | Co₃S₄/AC | 10 | 270 |
| 5 | Co₂P NWs | 10 | 280 |
| 6 | S:Co₂P@NF | 10 | 288 |
| 7 | Co₂P/N,P co-doped CNT | 10 | 292 |
| 8 | NiPS₃-G | 10 | 294 |
| 9 | (Co,Fe)₃N_2D | 10 | 310 |
| 10 | NiCo2S4@g- C₃N₄ - CNT | 10 | 330 |
| 11 | CoO/CoₓP | 10 | 370 |
| 12 | NiFe₂O₄—H₂ | 10 | 389 |

B—Co/Co₂N catalysts described herein display outstanding OER performance at high current densities, rarely achieved in previous investigations. For example, at an overpotential of about 350 and about 400 mV input, B—Co/Co₂N catalysts described herein can produce a OER current density of as high as about 352 mA/cm² and about 1000 mA/cm², respectively, which is about 6.3× and about 3.8× higher than that of Co/Co₂N (about 55 mA/cm² and about 268 mA/cm²) with the same potential input. While not wishing to be bound by any theory, such an excellent OER property may be attributed to the effect of the B dopant on improving the OER activity. For example, the B dopant may effectively and efficiently modulate the electronic structure of catalytic site(s) near the heterogeneous interface of the B—Co phase and the CO₂N phase.

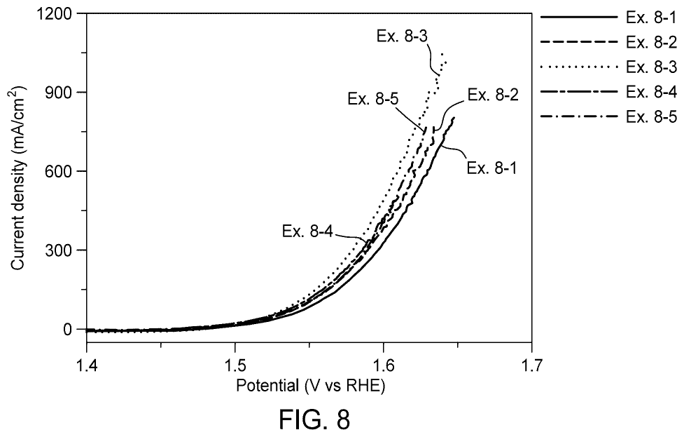

To confirm this hypothesis, the catalytic properties of B—Co/Co₂N with different B dopant amounts were investigated and results are shown in FIG. 8. FIG. 8 shows LSV curves of an example B—Co/Co₂N synthesized at about 350° C. for about 0.5 hours with varying amounts of boric acid for the boriding according to at least one aspect of the present disclosure. In FIG. 8, Ex. 8-1, Ex 8-2, Ex 8-3, Ex 8-4, and Ex 8-5 are 30 mg, 60 mg, 100 mg, 120 mg, and 250 mg boric acid, respectively. As depicted in FIG. 8, with increasing the amount of boric acid, the OER properties of B—Co/Co₂N exhibited a positive response, Ex. 8-3 achieved the best performance under the conditions tested.

Under the conditions tested, a further increase in the amount of boric acid can lead to a decay in OER activity. To further explore the effect of the B dopant on improving OER kinetics, the Tafel plots of catalysts were obtained from their LSV curves by the Tafel equation shown by Eq. 3:

$$η = a + b log j \qquad ( Eq . 3 )$$

wherein: η, j, and b represent overpotential, current density, and the Tafel slope, respectively.

As shown in FIG. 7C, the B—Co/Co₂N catalyst possesses a superior Tafel slope of about 30.5 mV/dec relative to that of Co/Co₂N (77.8 mV/dec), which indicates B dopant can efficiently accelerate the kinetics of OER activity for B—Co/Co₂N system and the third electron transfer (oxyhydroxide intermediate formation, M-OOH) is considered as the rate determined step for electrocatalytic oxygen evolution.

In addition, electrochemical impedance spectroscopy (EIS) was also performed to evaluate the charge transfer ability. Nyquist plots for B—Co/Co₂N and Co/Co₂N are compared in FIG. 7D, where the smaller the diameter of the semicircle represents lower resistance for charge transfer during OER process. In FIG. 7D, Z′ refers to real parts of the complex impedance and −Z″ refers to imaginary parts of the complex impedance.

Through Randel model fitting, the as-synthesized B—Co/Co₂N exhibits a lower charge transfer resistance (R_{ct}) of 10-100Ω relative to that of Co/Co₂N (100-300Ω), indicating that a faster charge transfer between electrode/electrolyte can be achieved on B—Co/Co₂N system during OER processes. Overall, the results indicate that B dopant can efficiently accelerate the reaction kinetics and can improve the ability of charge transfer through electrode/electrolyte interface, both of which can result in an improved OER performance in alkaline solution.

Long-term durability of an electrocatalyst was investigated. The stable performance at high current density for up-scale industrial applications is challenging due to, for example, peeling off of catalyst from the conductive substrate, aggregation of the particles with less active sites for OER, and/or transformation into various inactive phases. Therefore, the stability test of B—Co/Co₂N was performed by a continuous OER electrocatalysis at high current density. As shown in FIG. 7E, B—Co/Co₂N catalysts described herein can deliver an anodic current density of about 100 mA/cm² and about 500 mA/cm² for about 100 h with no degradation observed. Even when conducted at a current density of about 1,000 mA/cm² for about 100 h, the overpotential input only increased from about 410 mV to about 502 mV. Overall, the data indicates that B—Co/Co₂N catalysts described herein possess robust stability in alkaline solution, making it a promising anodic candidate for industrial water oxidation.

Aspects of the present disclosure generally relate to boron-doped cobalt/cobalt nitride interfacial catalysts, processes for making, and uses thereof. New B-doped Co/Co₂N interfacial electrocatalysts for use in, e.g., oxygen evolution reactions are presented. The B-doped Co/Co₂N (B—Co/Co₂N) interfacial electrocatalysts can be synthesized by heteroatom engineering. B—Co/Co₂N interfacial electrocatalysts described herein can exhibit excellent catalytic performance toward oxygen evolution in alkaline solution. For example, at overpotentials of about 262 mV and about 310 mV input, as-synthesized B—Co/Co₂N interfacial electrocatalysts described herein can produce excellent OER current densities of 10 mA/cm² and 100 mA/cm², respectively, without degradation. In addition, B—Co/Co₂N interfacial electrocatalysts of the present disclosure can exhibit excellent stability at industrial current densities of, e.g., 500 mA/cm² and 1000 mA/cm².

### Aspects Listing

The present disclosure provides, among others, the following aspects, each of which can be considered as optionally including any alternate aspects:

Clause 1. A process for forming a two-phase interface structure, the process comprising:
electrodepositing cobalt on a porous substrate;
exposing at least a portion of the cobalt deposited on the porous substrate to a boron-containing source to form a first composition comprising a boron-doped cobalt structure; and
exposing at least a portion of the cobalt deposited on the porous substrate to a nitrogen-containing source to form a second composition comprising a two-phase interface structure, the two-phase interface structure comprising: a first phase comprising boron-doped cobalt; and a second phase comprising cobalt nitride.

Clause 2. The process of Clause 1, wherein the electrodepositing the cobalt on the porous substrate comprises: preparing a mixture comprising a cobalt source and an electrolyte; and electrodepositing the cobalt on the porous substrate from the mixture at a current density that is from about −5.0 A/cm² to about −0.3 A/cm².

Clause 3. The process of Clause 2, wherein the cobalt source comprises cobalt chloride, cobalt sulfate, cobalt nitrate, a hydrate thereof, or combinations thereof.

Clause 4. The process of Clause 2 or Clause 3, wherein the electrolyte comprises at least one halide salt in a solvent, the solvent comprising water, an organic solvent, or combinations thereof; and/or the at least one halide salt comprises ammonium chloride, tin chloride, ammonium fluoride, ammonium bromide, or combinations thereof.

Clause 5. The process of Clause 4, wherein the at least one halide salt comprises ammonium chloride.

Clause 6. The process of any one of Clauses 1-5, wherein the boron-containing source comprises boric acid, diborane, boron trichloride, trimethyl borate, triethyl borane, lithium borate, sodium borate, potassium borate, sodium tetrafluoroborate, or combinations thereof.

Clause 7. The process of any one of Clauses 1-6, wherein the boron-containing source comprises boric acid.

Clause 8. The process of any one of Clauses 1-7, wherein the exposing the at least a portion of the cobalt deposited on the porous substrate to the boron-containing source to form the first composition is performed at a temperature that is 400° C. or less.

Clause 9. The process of any one of Clauses 1-8, wherein a molar ratio of boron to cobalt in the two-phase interface structure is from about 0.01:1 to about 0.3:1; and/or a molar ratio of nitrogen to cobalt in the two-phase interface structure is from about 0.1:1 to about 1:1.

Clause 10. The process of any one of Clauses 1-9, wherein the nitriding the at least a portion of the cobalt deposited on the porous substrate to form the second composition comprises: exposing the first composition to a nitriding gas at a temperature that is 400° C. or less.

Clause 11. A process for forming a two-phase interface structure, the process comprising:
preparing a mixture comprising a cobalt source and an electrolyte;
electrodepositing cobalt on a porous substrate from the mixture at a current density that is from about −5.0 A/cm² to about −0.3 A/cm²;
boriding at least a portion of the cobalt deposited on the porous substrate at a temperature of 400° C. or less to form a first composition comprising a boron-doped cobalt structure;
nitriding the first composition with ammonia gas at a temperature of about 200° C. to about 500° C. to form a second composition comprising a two-phase interface structure, the two-phase interface structure comprising: a first phase comprising boron-doped cobalt; and a second phase comprising cobalt nitride.

Clause 12. The process of Clause 11, wherein a molar ratio of boron to cobalt in the two-phase interface structure is from about 0.01:1 to about 0.3:1.

Clause 13. The process of Clause 11 or Clause 12, wherein a molar ratio of nitrogen to cobalt in the two-phase interface structure is from about 0.1:1 to about 1:1.

Clause 14. A two-phase interface structure, comprising: a first phase comprising boron-doped cobalt; and a second phase comprising cobalt nitride.

Clause 15. The two-phase interface structure of Clause 14, wherein a molar ratio of the boron to the cobalt in the two-phase interface structure is from about 0.01:1 to about 0.3:1.

Clause 16. The two-phase interface structure of Clause 14 or Clause 15, wherein a molar ratio of the nitrogen to the cobalt in the two-phase interface structure is from about 0.1:1 to about 1:1.

Clause 17. An oxygen evolution reaction electrocatalyst, comprising: the two-phase interface structure of any one of Clauses 14-16.

Clause 18. A composition for water splitting, comprising: the two-phase interface structure of any one of Clauses 14-16.

Clause 19. The composition of Clause 18, further comprising an alkaline solution.

Clause 20. A catalyst for catalyzing and electrolyzing water to produce oxygen, the catalyst comprising: the two-phase interface structure of any one of Clauses 14-16.

Where isomers of a named molecule group exist (for example, n-butyl, iso-butyl, sec-butyl, and tert-butyl), reference to one member of the group (for example, n-butyl) shall expressly disclose the remaining isomers (for example, iso-butyl, sec-butyl, and tert-butyl) in the family unless specified to the contrary or the context clearly indicates otherwise. Likewise, reference to a named molecule without specifying a particular isomer (for example, butyl) expressly discloses all isomers (for example, n-butyl, iso-butyl, sec-butyl, and tert-butyl) unless specified to the contrary or the context clearly indicates otherwise. When a compound is described herein such that a particular isomer, enantiomer or diastereomer of the compound is not specified, for example, in a formula or in a chemical name, that description is intended to include each isomer and enantiomer of the compound described individual or in any combination unless specified to the contrary or the context clearly indicates otherwise.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method, or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a boron-containing source” include aspects comprising one, two, or more boron-containing sources, unless specified to the contrary or the context clearly indicates only one boron-containing source is included.

While the foregoing is directed to aspects of the present disclosure, other and further aspects of the disclosure may be devised without departing from the basic scope thereof, and the scope thereof is determined by the claims that follow.

What is claimed is:

1. A process for forming a two-phase interface structure, the process comprising:
electrodepositing cobalt on a porous substrate;
exposing at least a portion of the cobalt deposited on the porous substrate to a boron-containing source to form a first composition comprising a boron-doped cobalt structure; and
exposing at least a portion of the cobalt deposited on the porous substrate to a nitrogen-containing source to form a second composition comprising a two-phase interface structure, the two-phase interface structure comprising:
a first phase comprising boron-doped cobalt; and
a second phase comprising cobalt nitride.

2. The process of claim 1, wherein the electrodepositing the cobalt on the porous substrate comprises:
preparing a mixture comprising a cobalt source and an electrolyte; and
electrodepositing the cobalt on the porous substrate from the mixture at a current density that is from about −5.0 A/cm² to about −0.3 A/cm².

3. The process of claim 2, wherein the cobalt source comprises cobalt chloride, cobalt sulfate, cobalt nitrate, a hydrate thereof, or combinations thereof.

4. The process of claim 2, wherein:
the electrolyte comprises at least one halide salt in a solvent, the solvent comprising water, an organic solvent, or combinations thereof; and
the at least one halide salt comprises ammonium chloride, tin chloride, ammonium fluoride, ammonium bromide, or combinations thereof.

5. The process of claim 4, wherein the at least one halide salt comprises ammonium chloride.

6. The process of claim 1, wherein the boron-containing source comprises boric acid, diborane, boron trichloride, trimethyl borate, triethyl borane, lithium borate, sodium borate, potassium borate, sodium tetrafluoroborate, or combinations thereof.

7. The process of claim 1, wherein the boron-containing source comprises boric acid.

8. The process of claim 1, wherein the exposing the at least a portion of the cobalt deposited on the porous substrate to the boron-containing source to form the first composition is performed at a temperature that is 400° C. or less.

9. The process of claim 1, wherein:
a molar ratio of boron to cobalt in the two-phase interface structure is from about 0.01:1 to about 0.3:1; and
a molar ratio of nitrogen to cobalt in the two-phase interface structure is from about 0.1:1 to about 1:1.

10. The process of claim 1, wherein the nitriding the at least a portion of the cobalt deposited on the porous substrate to form the second composition comprises:
exposing the first composition to a nitriding gas at a temperature that is 400° C. or less.

11. A process for forming a two-phase interface structure, the process comprising:
preparing a mixture comprising a cobalt source and an electrolyte;
electrodepositing cobalt on a porous substrate from the mixture at a current density that is from about −5.0 A/cm² to about −0.3 A/cm²;
boriding at least a portion of the cobalt deposited on the porous substrate at a temperature of 400° C. or less to form a first composition comprising a boron-doped cobalt structure;
nitriding the first composition with ammonia gas at a temperature of about 200° C. to about 500° C. to form a second composition comprising a two-phase interface structure, the two-phase interface structure comprising:
a first phase comprising boron-doped cobalt; and
a second phase comprising cobalt nitride.

12. The process of claim 11, wherein a molar ratio of boron to cobalt in the two-phase interface structure is from about 0.01:1 to about 0.3:1.

13. The process of claim 11, wherein a molar ratio of nitrogen to cobalt in the two-phase interface structure is from about 0.1:1 to about 1:1.

14. A two-phase interface structure, comprising:
a first phase comprising boron-doped cobalt; and
a second phase comprising cobalt nitride (Co₂N).

15. The two-phase interface structure of claim 14, wherein a molar ratio of the boron to the cobalt in the two-phase interface structure is from about 0.01:1 to about 0.3:1.

16. The two-phase interface structure of claim 14, wherein a molar ratio of the nitrogen to the cobalt in the two-phase interface structure is from about 0.1:1 to about 1:1.

17. An oxygen evolution reaction electrocatalyst, comprising:
the two-phase interface structure of claim 14.

18. A composition for water splitting, comprising:
the two-phase interface structure of claim 14.

19. The composition of claim 18, further comprising an alkaline solution.

20. A catalyst for catalyzing and electrolyzing water to produce oxygen, the catalyst comprising:
the two-phase interface structure of claim 14.
